(19) United States
(12) Patent Application Publication
(10) Pub. No.: US 2011/0079494 A1
(43) Pub. Date: Apr. 7, 2011

(54) BATTERY FOR HYBRID VEHICLES WITH A SAFETY DEVICE FOR INTERRUPTING A HIGH-VOLTAGE CIRCUIT

(75) Inventors: Ralf Joswig, Buchholz (Aller) (DE); Helge Brenner, Hannover (DE); Martin Wiegmann, Borstel (DE); Henning Eisermann, Edemissen / Abbensen (DE); Bernd Ide, Hannover (DE)

(73) Assignee: Johnson Controls Hybrid and Recycling GmbH

(21) Appl. No.: 12/940,834

(22) Filed: Nov. 5, 2010

Related U.S. Application Data
(63) Continuation-in-part of application No. PCT/EP2009/002525, filed on Apr. 6, 2009.

(30) Foreign Application Priority Data
May 8, 2008 (DE) 10 2008 022 840.0

(51) Int. Cl. H01H 9/20

(52) U.S. Cl. 200/50.01

(57) ABSTRACT

A rechargeable battery includes a housing and a plurality of electrochemical cells that are electrically connected to one another and form a high-voltage circuit. A high-voltage socket on the housing comprises two electrical poles, and the high-voltage socket is configured to be connected to a high-voltage plug. A catch on the high-voltage socket is configured to interact with a locking element on the high-voltage plug for locking the high-voltage plug to the high-voltage socket. A low-voltage circuit includes an integrated contactor for interrupting and closing the high-voltage circuit. A service plug connector is used for closing and disconnecting the low-voltage circuit; the service plug connector interacts with the high-voltage plug such that the high-voltage plug cannot be withdrawn from the high-voltage socket until the service plug connector has been removed from the rechargeable battery, and is configured to block the locking element on the high-voltage plug of the rechargeable battery.

### CROSS-REFERENCE TO RELATED PATENT APPLICATIONS

The present application is a continuation-in-part of International Application PCT/EP2009/002525, filed Apr. 6, 2009, which claims priority to German Patent Application DE 10 2008 022 840.0, filed May 8, 2008, both of which are incorporated herein by reference in their entireties, including the specification, drawings, claims and abstract thereof.

### BACKGROUND

The present application relates to a rechargeable battery for hybrid vehicles.

Rechargeable batteries are used, for example, in vehicles with a hybrid drive, in which one drive mode is electrical.

For maintenance and when servicing (for example repair) of the rechargeable battery are required, it is also necessary to switch the rechargeable battery such that it is not live. This is because, for safety reasons, it is necessary to be able to carry out maintenance tasks and servicing tasks on the rechargeable battery only in the switched-off state.

In general, the rechargeable battery is switched off via contactors (high-voltage relays) via which the circuit (high-voltage circuit), which is fed from the rechargeable battery, is linked to a low-voltage circuit. This link is provided such that the high-voltage circuit can be closed only when the low-voltage circuit is also closed. If the low-voltage circuit is in contrast open, the contactors ensure that the high-voltage circuit cannot be closed.

This safety precaution is subject to the problem that the high-voltage circuit and the low-voltage circuit can be interrupted at the same time. Simultaneous interruption of the high-voltage circuit and low-voltage circuit results in a risk of capacitor discharging, which can lead to health hazards to the maintenance personnel.

DE 10 2004 057 093 B3 discloses a plug connection having a first plug connector and a second plug connector, which respectively hold first contact elements and first mating contact elements which are connected to one another when the two plug connectors are connected to one another.

In the case of the plug connection, second contact elements can be connected to second mating contact elements only when the first contact elements and the first mating contact elements have made complete contact with one another, that is to say when the two plug connectors are in a completely connected state.

U.S. Pat. No. 7,084,361 B1 discloses a high-voltage plug connection which has a switching device. A switching plug connector which is formed in this way offers protection against connections which are at high voltage. A switch which is installed in the plug connector passes a signal to a control device to switch off the high voltage.

DE 101 02 242 A1 discloses a mobile apparatus which has a power generating device to which a power distribution system is connected which is at a higher voltage. Electrical loads are connected via flexible conductors and by means of plug connector halves at the conductor ends to a central control and distribution unit, which has a switch disconnector and/or a circuit breaker. Two plug connector halves which have been connected to one another can be disconnected, and the contact connection can be made with the halves, only when there is virtually no voltage on the plug connector contacts.

DE 197 10 416 A1 discloses a high-voltage plug connector in an electrical connecting line between a high-voltage source and a load, having two plug contact parts which can be plugged together and can be disconnected from one another again by means of an axial relative movement. In this case, a monitoring switch is provided which is operated during the disconnection movement of the two plug contact parts. The monitoring switch is connected to a control device, and the control device deactivates the high-voltage source with respect to the connecting line, when the monitoring switch is operated.

There is thus a need to provide an improved rechargeable battery in which the high-voltage circuit can be switched to be free of voltage safely.

### SUMMARY

An exemplary embodiment of the invention relates to a rechargeable battery for hybrid vehicles that includes a housing and a plurality of electrochemical cells within the housing that are electrically connected to one another and form a high-voltage circuit. The battery also includes a high-voltage socket arranged on the housing that comprises two electrical poles, wherein the high-voltage socket is configured to be connected to a high-voltage plug. A catch is provided on the high-voltage socket that is configured to interact with a locking element on the high-voltage plug for locking the high-voltage plug to the high-voltage socket. The battery also includes a low-voltage circuit and at least one contactor integrated in the low-voltage circuit for interrupting and closing the high-voltage circuit. A service plug connector for closing and disconnecting the low-voltage circuit interacts with the high-voltage plug such that the high-voltage plug cannot be withdrawn from the high-voltage socket until the service plug connector has been removed from the rechargeable battery. The service plug connector is configured to block the locking element on the high-voltage plug of the rechargeable battery.

Another exemplary embodiment relates to a rechargeable battery that includes a high-voltage circuit comprising a plurality of electrochemical cells, a high-voltage socket configured for coupling with a high-voltage plug, a low-voltage circuit comprising a contactor for interrupting and closing the high-voltage circuit, and a service plug connector for closing and disconnecting the low-voltage circuit. The service plug connector is configured to prevent removal of the high-voltage plug while the service plug connector is coupled to the battery.

Another exemplary embodiment relates to a service plug connector for a battery, the battery comprising a high-voltage circuit and a low-voltage circuit having a contactor for interrupting and closing the high-voltage circuit. The service plug connector is configured to prevent substantially simultaneous interruption or closing of the high-voltage circuit and the low-voltage circuit.

### BRIEF DESCRIPTION OF THE DRAWINGS

The invention will be explained in more detail with reference to one exemplary embodiment, which is illustrated in the following figures in which:

FIG. 1 shows a perspective partial view of a rechargeable battery according to the invention, with a service plug connector plugged on and a high-voltage plug plugged on,

FIG. 2 shows the rechargeable battery as shown in FIG. 1, with the service connecting plug withdrawn,

FIG. 3 shows the rechargeable battery as shown in FIG. 2 with the high-voltage plug withdrawn,

FIG. 4 shows a perspective front view of the service connecting plug,

FIG. 5 shows a perspective rear view of the service connecting plug,

FIG. 6 shows a rear view of the service plug connector, and

FIG. 7 shows a section view in the direction A from FIG. 6.

### DETAILED DESCRIPTION

According to an exemplary embodiment, a rechargeable battery for hybrid vehicles has a housing, a multiplicity of electrochemical cells, which are arranged in the housing, are electrically connected to one another, and form a high-voltage circuit. The rechargeable battery also includes a high-voltage socket, which is arranged on the housing and has two electrical poles, wherein the high-voltage socket can be connected to a high-voltage plug 2. The rechargeable battery also includes a catch, which is arranged on the high-voltage plug socket and interacts with a locking element which is arranged on the high-voltage plug, in order to lock the high-voltage plug to the high-voltage socket, a low-voltage circuit, and at least one contactor, which is integrated in the low-voltage circuit, for interrupting and closing the high-voltage circuit. A service plug connector is included for closing and disconnecting the low-voltage circuit, wherein the service plug connector interacts with the high-voltage plug such that the high-voltage plug cannot be withdrawn from the high-voltage socket until the service plug connector has been removed from the rechargeable battery, wherein the service plug connector is designed such that it blocks the lock on the high-voltage plug of the rechargeable battery.

The service plug connector interrupts the low-voltage circuit of the contactors for the rechargeable battery. The contactors are thus switched such that they interrupt the main voltage circuit.

The service plug connector is designed such that it blocks the lock on the high-voltage plug of the rechargeable battery. It is therefore impossible to withdraw the high-voltage plug of the rechargeable battery from the high-voltage socket as long as the service plug connector is arranged on the rechargeable battery, for example by being plugged onto low-voltage plugs, or being held in some other form. The high-voltage circuit and the low-voltage circuit can therefore be interrupted, and conversely connected, only successively in time. The interruption and closing of the high-voltage circuit and the low-voltage circuit with a time offset ensure that voltage is no longer present on the high-voltage contacts when the high-voltage plug is withdrawn from or plugged onto the high-voltage socket. This prevents capacitor discharging.

The rechargeable battery can therefore be safely made free of voltage by the maintenance and servicing personnel.

In one exemplary embodiment, the rechargeable battery has at least two low-voltage plugs which are integrated in the low-voltage circuit and onto which the service plug connector can be plugged in order to close the low-voltage circuit. The service plug connector for this purpose expediently has low-voltage sockets into which into which the low-voltage plugs can be inserted.

According to an exemplary embodiment, the service plug connector has a connector link, which makes an electrical connection between the at least two low-voltage plugs when the service plug connector has been plugged onto the at least two low-voltage plugs. For the plug connection, the service plug connector has low-voltage sockets into which the low-voltage plugs can be inserted according to an exemplary embodiment. The number of low-voltage sockets provided is expediently precisely the same as the number of low-voltage plugs. Two low-voltage plugs and two low-voltage sockets are provided in each case according to an exemplary embodiment. However, more than two low-voltage plugs and low-voltage sockets may also be provided, in order to provide a firmer seat for the service plug connector.

The service plug connector advantageously has an upper part and a lower part, which are screwed to one another. This embodiment allows simple maintenance and repair of the service plug connector.

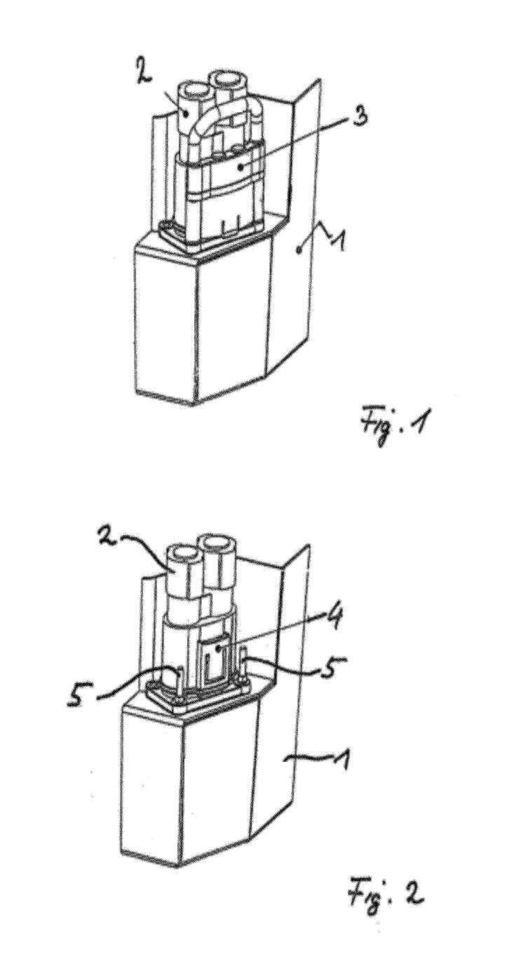

FIG. 1 shows a section of a battery housing 1. A high-voltage plug 2 is arranged on the battery housing 1. The high-voltage plug 2 can be removed from the battery housing 1. However, in FIG. 1, the service plug connector 3 prevents the high-voltage plug 2 from being removed from the battery housing 1.

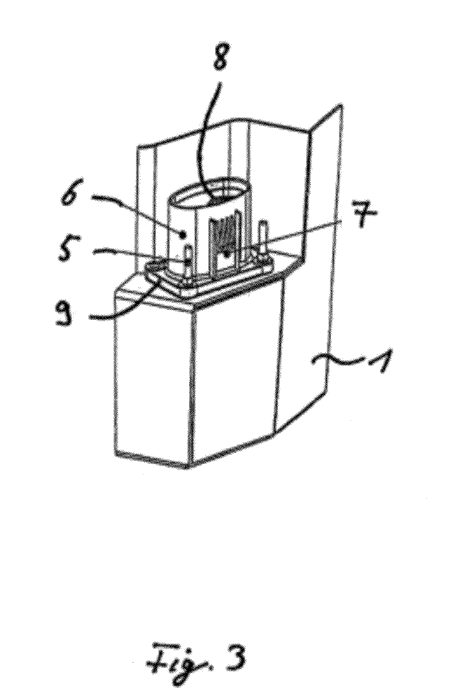

FIG. 2 shows the section of the battery housing 1 shown in FIG. 1, with the service plug connector 3 withdrawn. A lock 4 in FIG. 2 is now released.

The lock 4 is arranged on the high-voltage plug 2. The lock 4 interacts with the service plug connector 3 such that the high-voltage plug 2 cannot be withdrawn from the battery housing 1 as long as the service plug connector 3 is located above the lock 4.

FIG. 3 shows the section of the battery housing 1 from the previous figures with the high-voltage plug 2 withdrawn. This now shows a high-voltage socket 6 from which the high-voltage plug 2 has been released.

An external catch 7 is arranged on the high-voltage socket 6.

A high-voltage contact 8 can be seen in the high-voltage socket 6. A second high-voltage contact cannot be seen from this perspective. However, there are a total of two high-voltage contacts 8 in the high-voltage socket 6.

As can be seen, the high voltage socket 6 is attached to a base plate 9. The base plate 9 is attached to the battery housing 1.

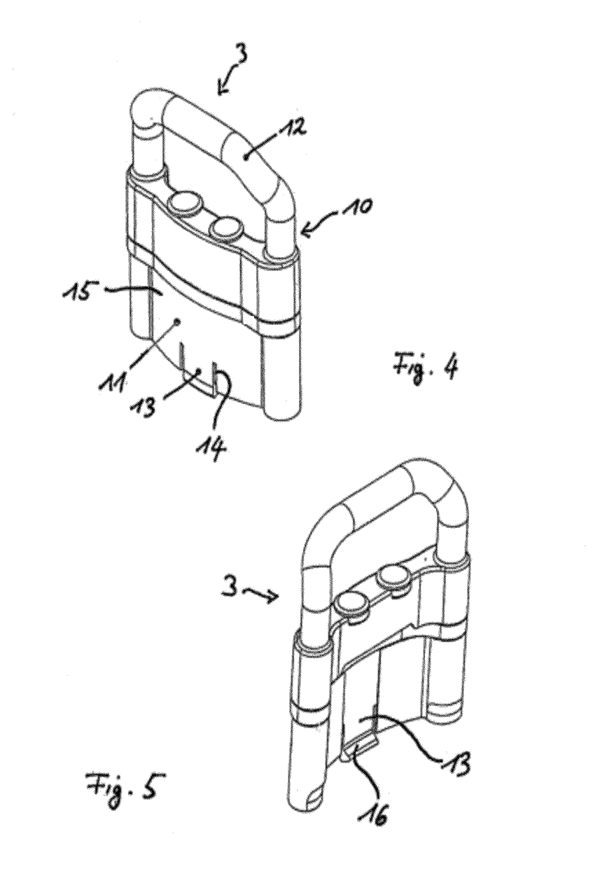

FIG. 4 shows the service plug connector 3 from FIG. 1, illustrated enlarged.

The service plug connector 3 has an upper part 10 and a lower part 11. The upper part 10 has a grip 12.

A further catch 13 is arranged on the lower part 11 and interacts with the catch 7 illustrated in FIG. 3.

Two incisions 14 in the lower part 11 can be seen to the side of the catch 13. The incisions 14 allow the catch 13 to spring out flexibly relative to an outer wall 15 of the lower part 11.

FIG. 5 shows the service plug connector 3 from FIG. 4, from the rear. The catch 13 has a projection 16 which extends toward a rear face. In the plugged-on state, the projection 16 engages under the lock 4 and holds the service plug connector 3 securely in the vertical direction when plugged on.

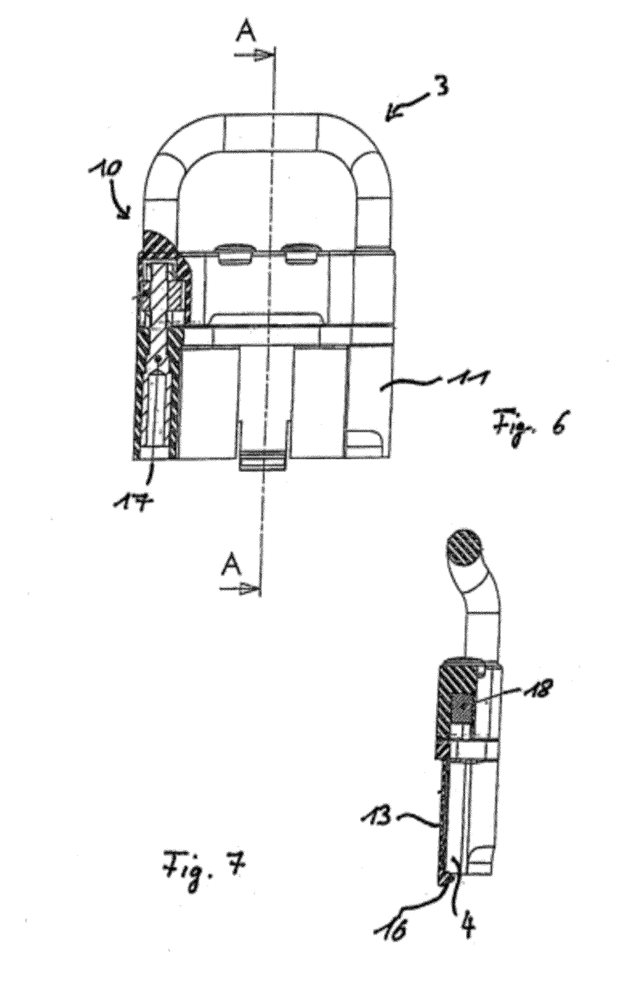

FIG. 6 shows the service plug connector 3 from FIGS. 4 and 5 in the form of a partial section from the rear.

The figure shows a low-voltage socket 17 which extends vertically upward. A connector link 18 can also be seen, running substantially horizontally.

The upper part 10 and the lower part 11 are screwed to the low-voltage socket 17 and to the connector link 18. A line 19 indicates a plane of symmetry for the service plug connector 3.

FIG. 7 shows a partial section view of the service plug connector 3 in the direction A from FIG. 6.

In this illustration, the service plug connector 3 has been plugged onto the low-voltage plugs 5 on the battery housing 1. This can be seen from the fact that the projection 16 of the catch 13 has engaged under the lock 4.

The connector link 18 can also be seen, in the form of a cross section.

In the plugged-on state, a low-voltage circuit (not illustrated) is closed via the low-voltage plugs 5, the low-voltage sockets 17 and the connector link 18.

According to an exemplary embodiment, a rechargeable battery for hybrid vehicles has a housing 1, a multiplicity of electrochemical cells, which are arranged in the housing 1, are electrically connected to one another, and form a high-voltage circuit. The rechargeable battery also includes a high-voltage socket 6, which is arranged on the housing 1 and has two electrical poles 8, wherein the high-voltage socket 6 can be connected to a high-voltage plug 2. The rechargeable battery also includes a catch 7, which is arranged on the high-voltage plug socket 6 and interacts with a locking element 4 which is arranged on the high-voltage plug, in order to lock the high-voltage plug 2 to the high-voltage socket 6. The rechargeable battery also includes a low-voltage circuit and at least one contactor which is integrated in the low-voltage circuit for interrupting and closing the high-voltage circuit. A service plug connector 3 is included for closing and disconnecting the low-voltage circuit, wherein the service plug connector 3 interacts with the high-voltage plug such that the high-voltage plug cannot be withdrawn from the high-voltage socket 6 until the service plug connector 3 has been removed from the rechargeable battery, wherein the service plug connector 3 is designed such that it blocks the lock (i.e., the locking element) on the high-voltage plug of the rechargeable battery.

According to a further exemplary embodiment, the rechargeable battery includes at least two low-voltage plugs 5 which are integrated in the low-voltage circuit and onto which the service plug connector can be plugged in order to close the low-voltage circuit.

According to a further exemplary embodiment, the service plug connector 3 has low-voltage sockets 17 into which the low-voltage plugs 5 can be inserted.

According to a further exemplary embodiment, the service plug connector 3 has a connector link 18, which makes an electrical connection between the at least two low-voltage plugs 5 when the service plug connector 3 has been plugged onto the at least two low-voltage plugs 5.

According to a further exemplary embodiment, the service plug connector 3 has an upper part 10 and a lower part 11 which are screwed to one another.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the rechargeable battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A rechargeable battery for hybrid vehicles comprising:
a housing;
a plurality of electrochemical cells within the housing that are electrically connected to one another and form a high-voltage circuit;
a high-voltage socket arranged on the housing that comprises two electrical poles, wherein the high-voltage socket is configured to be connected to a high-voltage plug;
a catch on the high-voltage socket that is configured to interact with a locking element on the high-voltage plug for locking the high-voltage plug to the high-voltage socket;
a low-voltage circuit;
at least one contactor integrated in the low-voltage circuit for interrupting and closing the high-voltage circuit; and
a service plug connector for closing and disconnecting the low-voltage circuit;
wherein the service plug connector interacts with the high-voltage plug such that the high-voltage plug cannot be withdrawn from the high-voltage socket until the service plug connector has been removed from the rechargeable battery; and
wherein the service plug connector is configured to block the locking element on the high-voltage plug of the rechargeable battery.

2. The rechargeable battery of claim 1, further comprising at least two low-voltage plugs that are integrated in the low-voltage circuit and onto which the service plug connector can be plugged to close the low-voltage circuit

3. The rechargeable battery of claim 2, wherein the service plug connector includes low-voltage sockets into which the low-voltage plugs can be inserted.

4. The rechargeable battery of claim 2, wherein the service plug connector has a connector link configured to make an electrical connection between the at least two low-voltage plugs when the service plug connector has been plugged onto the at least two low-voltage plugs.

5. The rechargeable battery of claim 1, wherein the service plug connector has an upper part and a lower part.

6. The rechargeable battery of claim 5, wherein the upper part is a grip and is screwed to the lower part.

7. A rechargeable battery comprising:
a high-voltage circuit comprising a plurality of electrochemical cells;
a high-voltage socket configured for coupling with a high-voltage plug;
a low-voltage circuit comprising a contactor for interrupting and closing the high-voltage circuit; and
a service plug connector for closing and disconnecting the low-voltage circuit;
wherein the service plug connector is configured to prevent removal of the high-voltage plug while the service plug connector is coupled to the battery.

8. The rechargeable battery of claim 7, wherein the high-voltage socket comprises a catch configured to engage a locking element on the high-voltage plug for releasably locking the high-voltage plug to the high-voltage socket.

9. The rechargeable battery of claim 8, wherein the catch and locking element form a lock.

10. The rechargeable battery of claim 8, wherein the service plug connector is configured to block access to the locking element.

11. The rechargeable battery of claim 7, wherein the service plug connector is configured to interact with the high-voltage plug such that the high-voltage plug cannot be withdrawn from the high-voltage socket until the service plug connector has been removed from the rechargeable battery.

12. The rechargeable battery of claim 7, wherein the service plug connector comprises a grip.

13. The rechargeable battery of claim 7, wherein the high-voltage socket comprises two electrical poles electrically connected to a plurality of electrochemical cells disposed within a housing of the battery.

14. A service plug connector for a battery, the battery comprising a high-voltage circuit and a low-voltage circuit having a contactor for interrupting and closing the high-voltage circuit, wherein the service plug connector is configured to prevent substantially simultaneous interruption or closing of the high-voltage circuit and the low-voltage circuit.

15. The service plug connector of claim 14, wherein the service plug connector is configured to interrupt and close the low-voltage circuit.

16. The service plug connector of claim 14, further comprising first and second low-voltage sockets that are configured to respectively receive first and second low-voltage plugs of the battery, and a link configured to electrically connect the first and second low-voltage plugs.

17. The service plug connector of claim 14, wherein the battery comprises a high-voltage plug socket having two electrical poles electrically connected to a plurality of electrochemical cells, the high-voltage plug socket configured to releasably connect to a high-voltage plug, and wherein the service plug connector is configured to prevent release of a connection between the high-voltage plug socket and high-voltage plug when the service plug connector is coupled to the battery.

18. The service plug connector of claim 17, wherein the service plug connector is further configured to releasably connect to the high-voltage plug.

19. The service plug connector of claim 17, wherein the high-voltage plug socket comprises a catch, the high-voltage plug socket comprises a locking element, and wherein the service plug connector is configured to block access to the locking element.

20. The service plug connector of claim 17, further comprising a catch configured to interact with a portion of the high-voltage plug to form another releasable lock.
